(19) United States
(12) Patent Application Publication
(10) Pub. No.: US 2021/0188681 A1
(43) Pub. Date: Jun. 24, 2021

(54) Wastewater Treatment Method and System for Removal of Phosphorus, Nitrogen and Coliforms

(71) Applicant: 11814192 Canada Inc., Sherbrooke, Quebec (CA)

(72) Inventor: Benoit Boucher, Sherbrooke, Quebec (CA)

(21) Appl. No.: 17/272,639

(22) PCT Filed: Sep. 3, 2019
(86) PCT No.: PCT/CA2019/051229

§ 371 Date: Mar. 1, 2021

Related U.S. Application Data
(60) Provisional application No. 62/725,752, filed on Aug. 31, 2018.

(51) Int. Cl. C02F 9/00; B01D 39/06

(52) U.S. Cl. CPC C02F 9/00; C02F 2001/007; B01D 39/06

(57) ABSTRACT

A novel wastewater treatment method, apparatus and system to treat wastewater from septic tanks, including a tertiary treatment for the passive removal of phosphorus, nitrogen and coliforms from sewage streams, is described. The method, apparatus and systems comprise a septic tank, an enviro-septic system, a dephosphatation system, a denitrification system and a polishing field, including related piping distribution and pumping systems. The invention further comprises an enviro-septic system comprising an advanced enviro-septic pipe, a filtration medium, a collection drain and associated distribution systems; a polishing field comprising an advanced enviro-septic pipe, a collection drain, a filtration medium, a collection drain and associated distribution systems; and a dephosphatation system comprising a filtration medium for the removal of phosphorus and coliforms and a denitrification system comprising a filtration medium for the removal of nitrogen. The wastewater treatment method is used to treat domestic, industrial and commercial sewage effluent.

### CROSS-REFERENCE TO RELATED APPLICATIONS

The present application claims the benefit of U.S. Provisional Patent Application No. 62/725,752 filed on Aug. 31, 2018, the contents of which are hereby incorporated by reference.

### FIELD OF THE INVENTION

The present invention generally relates to the field of wastewater and sewage treatment. More particularly, the invention concerns the passive removal of phosphorus, nitrogen and coliforms from wastewater and sewage.

### BACKGROUND OF THE INVENTION

Enviro-septic systems provide a natural way to treat wastewater while minimizing energy and maintenance costs. Representative enviro-septic systems are described in U.S. Pat. Nos. 8,999,153 and 9,556,604 (Presby). These systems rely on the use of smooth or corrugated septic conduits of various forms that can be used in combination with a drainage system associated with a septic system.

Phosphorus, nitrogen and coliform removal from wastewater streams is a challenge faced by any wastewater treatment method. Wastewater sources are responsible for most of the phosphorus present in surface water environments. Among other disadvantages, an excess of phosphorus in the environment is associated with eutrophication.

Over the years, many methods have been proposed to remove phosphorus. The removal of phosphorus can be achieved through biological, chemical or physical means. In a biological method, the removal is carried out through the use of bacteria or plants, while in a chemical method, the removal is achieved by chemical agents that result in the production of a sludge. Since most treatment methods to precipitate phosphates are of a chemical nature and costly, there has been a drive over the last few years to develop efficient and lower-cost alternatives.

Lower cost treatment plants usually involve the passive removal of phosphate using physical means, such as filters. The passive removal of contaminants represents a more efficient and less energy intensive method to treat wastewater. As an example, U.S. Pat. No. 9,682,879 (Dube et al.) teaches the use of activated wood chips and peat moss to remove phosphorus from wastewater streams. US Patent Publication No. US 2010/0243571 (Semiat et al.) describes the passive removal of phosphorus using particles of transition metals oxides or hydroxides, TiO₂, or mixtures thereof, as well as particles of activated carbon, activated alumina, aluminium oxide, activated TiO₂, mineral clay, zeolite and even an ion exchanger using nanoparticles of these materials. Another example in which the use of oxides to remove contaminants is disclosed is US Patent Publication No. US 2011/0303609 (Isovitsch Parks et al.).

Alternative methods for the removal of phosphorus include the use of zeolite in circulation adsorption columns, as described in KR 1016822907 (Seok et al.), and the use of support media containing metals, as taught by CA 2,305,014A1 (Cronitech). In yet another example of an alternative method to remove phosphorus, peat moss was used as a green filtration medium, as disclosed in U.S. Pat. No. 7,927,484 (Wanielista et al.).

Microbial pollution is caused by the presence in water of pathogenic micro-organisms from human and animal excreta from various sources. These releases can cause microbial contamination that may compromise the safe practice of water use, such as shellfish consumption, as well as a plethora in recreational activities involving direct contact with water and indirect contact with water, not to mention that a poor quality of raw water can increase the difficulties of treatment of drinking water. For public health reasons, it is often necessary to disinfect wastewater before it is discharged into surface water. Popular disinfection techniques that do not cause adverse effects on aquatic life and do not generate undesirable by-products for public health include ozonation, ultraviolet radiation, lagooning, various filtration systems and chlorination systems.

Despite the above developments in the field of phosphorus removal from wastewater, there remains a need for an efficient and complete wastewater treatment method and system based on the passive removal of phosphorus, nitrogen and coliforms with reduced energy and maintenance costs. The present invention seeks to address this need by providing a complete method to treat wastewater originating from domestic, commercial and industrial sewage streams and septic tanks.

### SUMMARY OF THE INVENTION

A solution to the shortcomings of the prior art is proposed by a novel passive wastewater treatment method and system for the removal of phosphorus, nitrogen and coliforms.

The present invention comprises a novel wastewater treatment method, apparatus and system to treat wastewater streams through the removal of phosphorus, nitrogen and coliforms. The invention may further comprise the removal of phosphorus, nitrogen and coliforms from sewage streams.

In one aspect of the invention, a system for the removal of phosphorus of phosphorus and coliforms is provided. The system comprises an enviro-septic system, a dephosphatation system fluidly connected to the enviro-septic system and a polishing field fluidly connected to the dephosphatation system.

In another aspect of the invention, a system for the removal of nitrogen, phosphorus and coliforms may comprise an enviro-septic system, a denitrification system, a dephosphatation system and a polishing field.

In yet another aspect of the invention, a method comprises primary, secondary and tertiary wastewater treatment steps. The primary treatment step comprises a septic tank with associated pumping stations and pipelines. The secondary treatment step comprises using an enviro-septic system, such as an Advanced Enviro-Septic™ (or AES) system, also described as an AES pipe, with associated distributions systems, pipelines, filtering media and collection systems. The tertiary treatment step comprises a dephosphatation system to remove phosphorus and coliforms followed by a polishing field. The method may further comprise the inclusion of a denitrification step for the removal of nitrogen either before or after the dephosphatation step, followed by a polishing step.

In another aspect of the invention a wastewater treatment method for the removal of phosphorus and coliforms is provided. The method comprises the steps of settling a wastewater stream in a septic tank, filtering the wastewater stream in an enviro-septic system, removing phosphorus from the wastewater stream with a dephosphatation system and filtering the wastewater stream using a polishing field.

In a further aspect of the invention, a wastewater treatment method for the removal of phosphorus, nitrogen and coliforms is provided. The method comprises the steps of settling a wastewater stream in a septic tank, filtering the wastewater stream in an enviro-septic system, removing nitrogen from the wastewater stream using a denitrification medium, filtering the wastewater stream using a polishing field; and removing phosphorus from the wastewater stream with a dephosphatation medium.

Other aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 is a flowchart of an embodiment of a wastewater method for the removal of phosphorus and coliforms in accordance with the invention;

FIG. 2 is a flowchart of an embodiment of a wastewater treatment method for the removal of nitrogen, phosphorus and coliforms in accordance with the invention;

FIG. 3 is a schematic illustration of a representative system used in the wastewater treatment method for the removal of phosphorus and coliforms in accordance with the invention;

FIG. 4 is a schematic illustration of a representative system involved in the wastewater treatment method for the removal of nitrogen, phosphorus and coliforms in accordance with the invention;

FIG. 5 is an alternative representative schematic illustration of an enviro-septic system in accordance with the invention;

FIG. 6 is another alternative representative schematic illustration of a polishing field in accordance with the invention;

FIGS. 7 and 8 are illustrations of examples of an enviro-septic system in accordance with the invention;

FIGS. 9 and 10 are illustrations of representative examples of a polishing field in accordance with the invention;

FIG. 11 is an illustration of an example of a low-pressure partition system (LPPS) in accordance with the invention; and

FIG. 12 is an illustration of an example of a low-pressure distribution system (LPDS) in accordance with the invention.

### DETAILED DESCRIPTION OF THE PREFERRED EMBODIMENT

A novel wastewater treatment method, apparatus and system for the removal of phosphorus and coliforms will be described hereinafter. Although the invention is described in terms of specific illustrative embodiments, it is to be understood that the embodiments described herein are by way of example only and that the scope of the invention is not intended to be limited thereby.

For purposes of the present application, the following expressions have the following meanings:

Enviro-septic system: a system based on the combination of one or more corrugated and perforated pipe covered by layers of material used to treat wastewater by creating aerobic and anaerobic digestion;
Low pressure partition system (LPPS): a system that allows the effluent from an enviro-septic system to be divided between different rows of pipes;
Low pressure distribution system (LPDS): a system that allow the effluent of the enviro-septic system to pass between and through different rows of pipes;
Denitrification system: a system that allows the denitrification of the effluent of the enviro-septic system;
Dephosphatation system: a system that allows phosphorus present in the effluent of an enviro-septic system to be captured; and
Polishing field: a system (“field”) that allows polishing or infiltration of the effluent of an enviro-septic system.

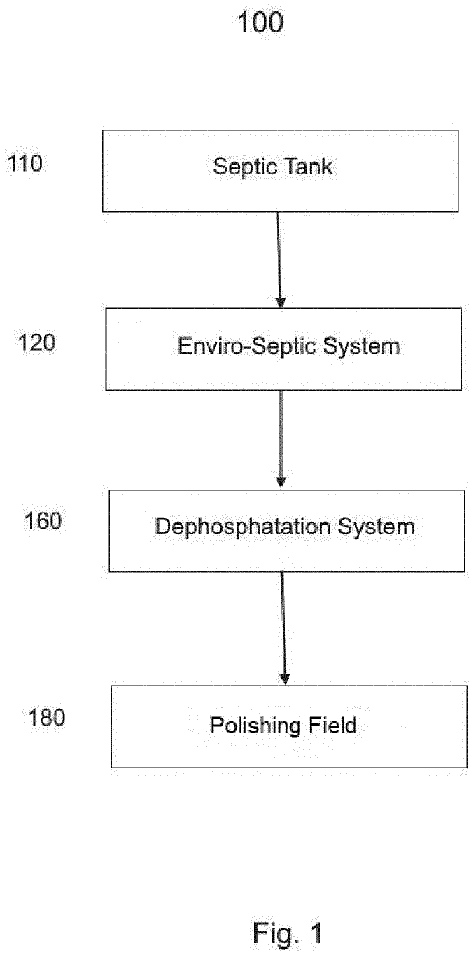

In a first embodiment of the present invention, a wastewater treatment method for the removal of phosphorus and coliforms 100 is illustrated in FIG. 1. The method 100 comprises settling of a wastewater stream in a septic tank 110, filtering the wastewater stream in an enviro-septic system 120, such as, but not limited to, an Advanced Enviro-Septic™ system, removing the phosphorus and the coliforms from the wastewater stream with a dephosphation system 160, and filtering the wastewater stream using a polishing field 180.

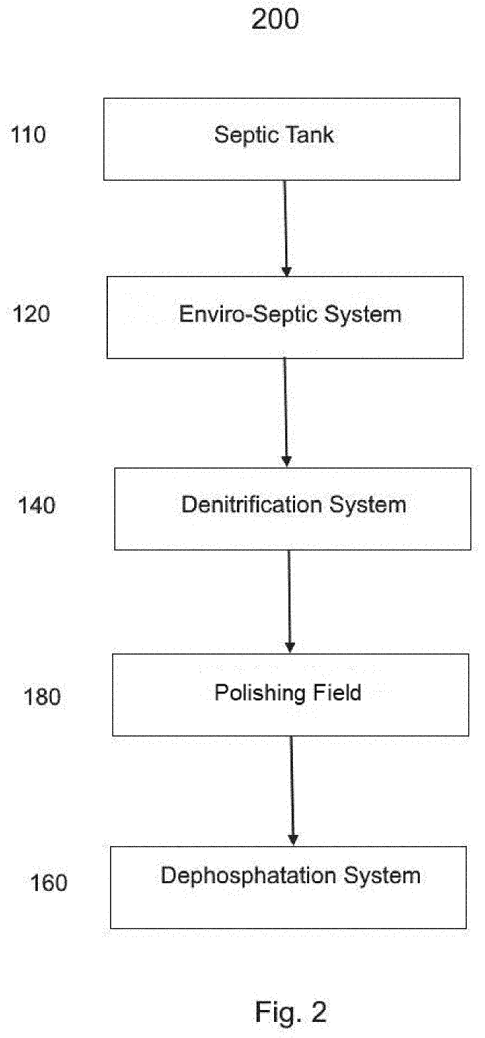

Now referring to FIG. 2, an embodiment of a wastewater treatment method for the removal of nitrogen, phosphorus and coliforms 200 is described. The method 200 comprises settling of the wastewater stream in the septic tank 110, filtering the wastewater stream in an enviro-septic system 120, such as but not limited to an Advanced Enviro-Septic™ system, removing the nitrogen from the wastewater stream using a denitrification medium 141, filtering the wastewater stream using a polishing field 180 and removing the phosphorus and coliforms from the wastewater stream with a dephosphation system 160.

One skilled in the art will appreciate that the order of certain steps of the wastewater treatment method for the removal of nitrogen and phosphorus 200 may be changed without departing from the present invention. For example, the removal of phosphorus may be performed before the removal of nitrogen, and the filtering of the wastewater stream using a polishing field may be the final step in the method.

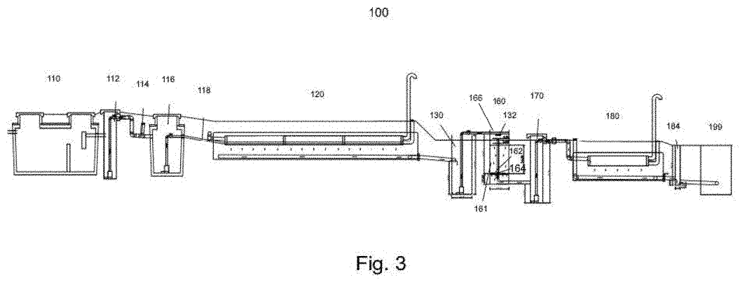

FIG. 3 illustrates another embodiment of a system 10 for treating wastewater following method 100 illustrated in FIG. 1. The system 10 generally comprises a septic tank 110 fluidly connected to a first pumping station 112. The first pumping station 112 is fluidly connected to a low-pressure distribution system connected to a second pumping station 116. The second pumping station 116 is adapted to pump wastewater in a septic field 120. A third pumping station 130 is configured to pump wastewater liquid from the septic field 120 to a denitrification system 140. The system 10 may further comprise polishing field 180 fluidly connected to the third pumping station 130 and to a fourth pumping station 184. The system may further comprise a dephosphatation system 160 fluidly connected to the outlet of the fourth pumping station 184. The system 10 may further comprise an outlet or exit 199.

In some embodiments, the septic tank 110 comprises an outlet allowing water to flow by gravity towards the first pumping station 112. The first pumping station 112 is configured to pump, the water/liquid is pumped to feed the low-pressure distribution system. In some embodiments, the low-pressure distribution system is fed via a first low pressure partition system (LPPS 1) 114.

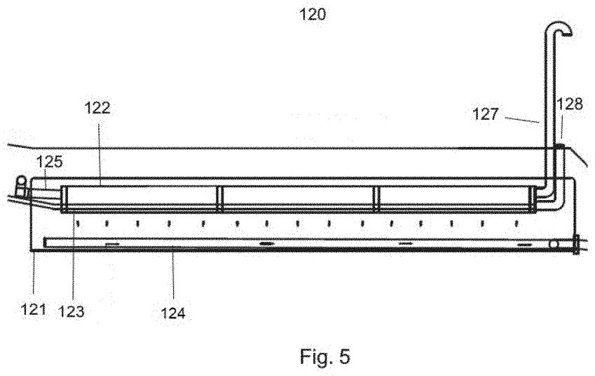

In some embodiments, the LPPS may comprise a plurality of input and output ports. In some of such embodiments, the LPPS may comprise five (5) ports, two of the ports being configured to feed other enviro-septic systems pipelines, also described as AES pipes 122 (shown in FIGS. 5, 7 and 8) and the last three of the ports being fluidly connected to the second pump station 2 116.

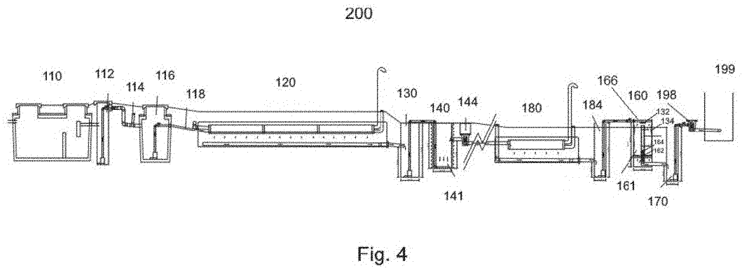

The second pump station 116 may be configured to feed a second low pressure distribution system (LPDS 2) 123 (shown in FIGS. 5, 7 and 8). In some embodiments, the second pump station 116 feeds the LPDS 2 123 via a low-pressure partition system (LPPS 2) 118. The LPDS 2 123 may, for example, comprise 18 calibrated ports configured to feed three lines toward enviro-septic systems, including the line of the present method, such as using 6 calibrated ports per row of lines. The outlet of the septic field 120 may be configured to convey the effluent to the third pumping station 130. From the third pumping station 130, the water may be pumped to a dephosphatation system 160 onto the top of a dephosphatation medium 161 such as via a diffuser 132. Subsequently, the liquid may infiltrate and pass through the dephosphating medium 161 and accumulate in the bottom of a tank 166. In some embodiments, the system 10 further comprises a geogrid 162 (shown in FIGS. 3 and 4) adapted to allow liquid to pass through. One of skill in the art will appreciate that endless configurations of the elements of the system are possible and that the present invention is not limited by the description of any specific configuration.

In some embodiments, the tank 166 may comprise a pipe having perforations located about the center of the tank 165. In such embodiment, after an accumulation of liquid at the bottom of the tank 166, such as approximately 200 mm of liquid, the effluent may pass through the perforations of the pipe. This pipe may further comprise a filter 164 (shown in FIGS. 3 and 4).

In such embodiments, the liquid is conveyed to the fourth pumping station 184. From the fourth pumping station 184, the water is pumped to the polishing field 180. At the outlet of the polishing field 180, the effluent is collected and then conveyed by gravity to the sampling point 184. In some embodiment, after rising water to a predetermined level in the well, such as about 50 mm, the liquid may exit the site through the outlet 199 (shown in FIGS. 3 and 4).

FIG. 4 shows another embodiment of a system 20 configured to treat wastewater according to method 200 (illustrated in FIG. 2) adapted for the removal of nitrogen, phosphorus and coliforms. In such an embodiment, the septic tank 110 comprises an outlet connected to the first pumping station 112, the liquid typically flowing to the first pumping station 112 through gravity. From the first pumping station 112, the water may be pumped to feed a low-pressure distribution system (LPDS) 123 (shown in FIGS. 5, 7 and 8) via a low-pressure partition system LPPS 114. The low-pressure distribution system may comprise a plurality of input and output ports. In some of such embodiments, the LPPS 114 comprises five (5) ports with the first two ports adapted to feed two pipelines and the last three ports adapted to feed a second pump station 116. The second pump station 116 may adapted to feed a second pressure distribution system LPDS 123 (shown in FIG. 5) via a second low-pressure partition system LPPS 2 118. The LPDS 123 may further comprise a plurality of ports, such as calibrated ports. As an example, the LPDS 123 may comprise 18 calibrated ports fluidly connected to three lines, including the lines in the present method, with 6 calibrated ports per row of lines. The enviro-septic system 120 may comprise an exit or an outlet fluidly connected to a a third pumping station 130 and adapted to convey the effluent to the third pumping station 130. From the third pumping station 130, the water is pumped into the denitrification system 140 at bottom of the tank comprising a denitrification medium 141. The wastewater may then rise to the surface through the denitrification medium 141. After passing through the denitrification medium 141, the water may flow by gravity to the sampling point 144. After rising water to a predetermined level, such as about 50 mm, at the outlet of the sampling well, the effluent may flow to a polishing field 180. At the outlet of the polishing field 180, the effluent may be collected and then transported by gravity to a fourth pumping station 184. The fourth pumping station 184 is fluidly connected to to a dephosphatation system 160 and is adapted to convey the liquid or effluent to a dephosphatation medium 161, such as via a diffuser 132. Subsequently, the liquid infiltrates the dephosphating medium 161 and may accumulate in the bottom of the tank. A geogrid 162 may further be added to further filter the liquid. After an accumulation of a predetermined height of water, such as about 200 mm at the bottom of the tank, the effluent may pass through a perforated pipe, such as a pipe within the center of the tank. This pipe may further comprise a filter 164. The water is thus conveyed to a fifth pumping station 170. From this fifth pumping station 170, the water is pumped to a sampling point 198 before being conveyed by gravity towards the exit of the site 199.

Now referring to FIG. 5, an embodiment of the enviro-septic system 120 is further detailed. In such an embodiment, the enviro-septic system 120 comprises a chamber 121, a perforated pipe 122, such as but not limited to an Advanced Enviro-Septic™ pipe (also described as an AES pipe), layers of materials placed on the bottom of the chamber 121, and a collection drain 124 located about the center.

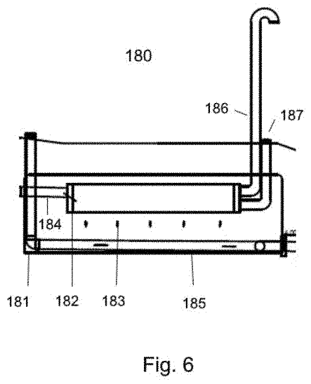

Now referring to FIG. 6, an embodiment of the polishing field 180 is illustrated. The polishing field 180 may further comprise a chamber 181, layers of material 183, a perforated pipe and a collection drain 185.

Referring back to FIG. 4, the dephosphatation system 160 may comprise a dephosphatation medium 161 and may further comprise a filtration medium 164 generally aiming at removing the phosphorus and the coliforms present in the effluent.

In another embodiment of the present invention, the systems involved in the wastewater treatment for the removal of phosphorus and coliforms of method 100 (FIG. 1) and the removal of nitrogen, phosphorus and coliforms of method 200 (FIG. 2) may be comprised of the elements described in the following examples, wherein any specified sizes or dimensions are approximate and provided for illustrative purposes only:

### Example 1: Enviro-Septic System

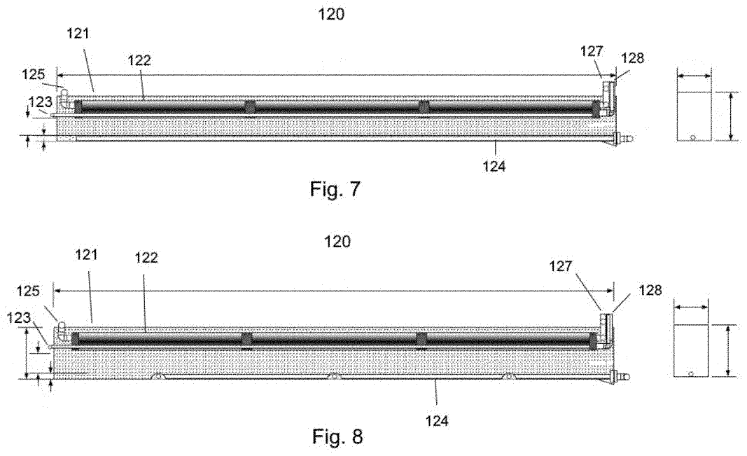

Now referring to FIG. 7, an exemplary enviro-septic system 120 is illustrated. In such an example, the length of the chamber 121 may be 9.75 m, wherein the total length represents three sections of 3.05 m and 0.3 m at each end. The width of the chamber may be 0.6 m which is equivalent to the minimum center-to-center spacing between rows of pipes. The total useful height of the chamber may be 85 cm. The chamber 121 may be further placed on a slope of 0.5% towards the exit. The layers of materials placed from the bottom of the chamber may comprise the following:
a first layer comprising a collection drain 124 typically surrounded by crushed stones. As an example, the first layer may have a thickness of about 7.5 to 12.5 cm of crushed stone and the collection drain may be positioned 7.5 cm in the center;
a second layer of geogrid;
a third layer of filtration medium, such as a sand filtration medium. As an example, the third layer may have a thickness of about 15-60 cm;
a fourth layer filtration medium comprising an pipe 122. As an example, the filtration medium may be sand and/or have a thickness of about 30 cm of sand and the pipe may be a low-pressure pipe in the AES pipe;
A fifth layer filtration medium. As an example, the filtration medium may be sand and/or have a thickness of about 10 cm.
A sixth layer sand or fill soil taken on site. As an example, the sixth layer may have a thickness of about 20 cm.

In some embodiments, the chamber upstream end may comprise an adapter having two openings. The first opening, typically located on top, may be adapted to receive a ventilation duct 125, such as a ventilation duct having a diameter of 100 mm. The second opening may be provided at the bottom to pass a pipe of the distribution system LPDS 123. In such an example, the opening and the pipe may each have 50 mm diameters.

Still in the present example, the chamber downstream end may comprise an adapter having two openings adapted to receive the ventilation pipe in the top hole 127 and a piezometer 128 in the bottom hole. The access point for the low-pressure pipe may be through the piezometer.

The collection drain 124 may leave from the base of the caisson on the downstream side and may arrive at the sampling point 130 where it may be directed to a pumping station 130, as shown in FIG. 3.

### Example 2: Enviro-Septic System

Now referring to FIG. 8, another example of an enviro-septic system 120 is further detailed. In such an example, the length of the chamber 121 is 9.75 m, wherein the total length represents three sections of 3.05 m and 0.3 m at each end. The width of the chamber is 0.6 m which is equivalent to the minimum center-to-center spacing between rows of pipes. The total useful height of the box is 90 cm. The chamber may be further placed on a slope of 0.5% towards the exit.

In such an example, the layers of materials placed from the bottom of the chamber may comprise the following:
a first layer comprising a collection drain 124 and a rough filtration medium. As an example, the rough filtration medium may be a layer of crushed stones, typically having an height from 7.5 to 10 cm. As an example, the collection drain 124 may have a diameter of 7.5 cm or 10 cm and may be placed in the center with the rough filtration medium surrounding the collection drain 124 where the liquid may be collected and directed to the pumping station 130.
a second layer of geogrid.
a third layer of fine filtration medium, such as sand having about 35 cm thick sand filtration medium.
a fourth layer of fine filtration medium comprising a perforated pipe, such as in the center, and a low-pressure pipe within the perforated pipe. In such an example, the fine filtration medium may be sand and may have a thickness of about 30 cm.
a fifth layer of fine filtration medium, such as a 10 cm thick of sand filtration medium.
a sixth of sand or backfill soil taken on site; such layer may have a thickness of about 20 cm.

The chamber may comprise an upstream end and a downstream end. The chamber upstream end may be equipped with an adapter having two openings 125. The first opening 125 may be located on top and may be adapted to receive a ventilation duct, such as a duct having a diameter of about 100 mm. The second opening, such as an opening having a diameter of about 50 mm, may be located at the bottom of the chamber to pass the pipe of the distribution LPDS 2 123. The diameter of the pipe may be adapted to be the same as the diameter of the second opening.

the chamber downstream end may comprise an adapter having two openings adapted to receive a ventilation pipe in the top hole 127 and a piezometer in the bottom hole 128. The access point for the low-pressure pipe may be through the piezometer.

The collection drain 124 (shown more clearly in FIG. 5) may be located at the base of the caisson on the chamber downstream end and may arrive at the sampling point 130 where it may be directed to a pumping station 130, as shown in FIG. 3.

### Example 3: Polishing Field

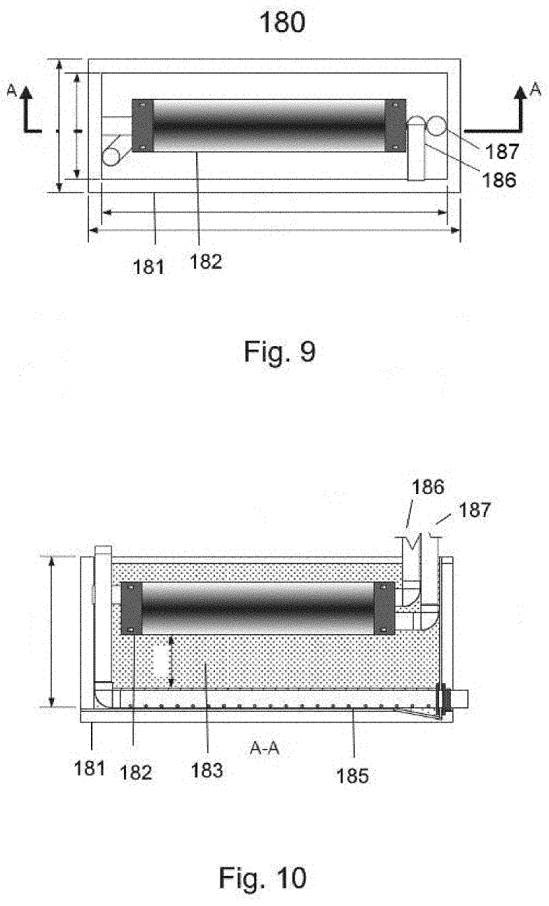

Referring now to FIGS. 6, 9 and 10, an exemplary polishing field 180 is illustrated. The polishing field 180 may further comprise, as shown in FIGS. 9 and 10, a chamber 181. In such an example, the chamber 181 may have the following dimensions: a length of 2.125 m, wherein it may comprise half a section of 3.05 m plus 0.3 m at each end; a width of 0.6 m equivalent to the minimum center-to-center spacing between rows of ducts. The chamber may be further placed on a slope of 0.5% towards the exit. The total useful height of the chamber may be 85 cm.

In the present example, the layers of materials 183 in the polishing chamber 181 may be located on the bottom of the box and may further comprise the following materials from the bottom of the box:
from 7.5 to 12.5 cm of crushed stones and a collecting drain in the center, such as a collecting drain having a 7.5 cm diameter,
geogrid,
a first fine filtration medium, such as about 30 cm thickened of sand filtration medium.
A second sand filtration medium with a perforated pipe 182 in the center. In such an example, the second sand filtration medium may have a thickness of about 30 cm.
a third sand filtration medium, such as a 10 cm thick sand filtration medium.
sand or backfill soil taken on site; such layer may have a thickness of about 20 cm.

The polishing field 180 may comprise an upstream end and a downstream end. The upstream end may comprise an adapter with one opening configured to receive a pipe 184 from the dephosphatation system. In some embodiments, the pipe may have a diameter of 100 mm.

The downstream end of the polishing field 180 may be comprise two openings configured to receive the vent pipe 186 in the top port and a piezometer 187 in the bottom port. The access tube of the pipe under low pressure typically passes through the piezometer.

The polishing field 180 may further be fluidly connected to a collection drain 185. In such an embodiment, the effluent is collected at the bottom of the chamber of the polishing field 180 by the collection drain 185. The collection drain 185 may further be connected to a sampling point 184. Such sampling point 184 where it may be directed to another treatment step which may be a dephosphatation system 160 or to the exit 199 of the treatment system, as shown in FIG. 4.

### Example 4: Dephosphatation System

In another example, the dephosphatation system 160 (shown in FIG. 4) may comprise a dephosphatation medium 161 within a sealed container. Without restricting the invention to such dimensions, in such example, the dephosphatation medium 161 may have a volume of 0.3 m³ and the sealed container may have the shape of a cylinder, such as but not limited to a cylinder having a diameter of about 60 cm and a height of about 90 cm. The effluent outputting from the dephosphatation system 160 may be directed to a sampling point 170. In another embodiment, the dephosphatation system 160 may further comprise a dry membrane 134.

### Example 5: Denitrification System

In another example, the denitrification system 140 (shown in FIG. 4) may comprise a denitrification medium 141. In some embodiments, the denitrification medium 141 is made of white birch, such as about 48 bags of white birch. The denitrification medium 141 compartment may be embodied as a cylindrical tank, such as a cylinder tank having a diameter of about 60 cm and a height of about 150 cm.

### Example 6: Pumping Station from Enviro-Septic System to Dephosphatation System

In yet another example, the enviro-septic system may comprise an outlet fluidly connected to a pumping station 130 (shown in FIG. 3). The pumping station 130 may further comprise a well. In some embodiments, the well has a cylindrical shape. In yet other embodiments, the well has a diameter of about 60 cm and a depth of about 183 cm. The pumping station 130 may further comprise a submersible pump, such as but not limited to a Little Giant® ½ hp, 115 volts with an hourly cycle.

### Example 7: Pumping Station from Dephosphatation to Polishing

The dephosphatation system 160 may comprise an outlet fluidly connected to a pumping station 170 (shown in FIG. 3). The pumping station 170 may further comprise a well. In some embodiments, the well has a cylindrical shape. In yet other embodiments, the well has a diameter of about 38 cm and a depth of about 183 cm. The pumping station 170 may further comprise submersible pump. As an example, the submersible pump may be a Little Giant® ½ hp, 115 volts operating on demand following a high-water level float. This pumping system may further comprise an outlet adapted to direct the resulting effluent from the dephosphatation system 160 to the polishing field 180 (FIG. 3).

### Example 8: Pumping Station from Enviro-Septic System to Denitrification System

The enviro-septic system may further comprise an outlet fluidly connected to a pumping station 130, the outlet being adapted to direct the effluent. The pumping station 130 may further comprise a well. In some embodiments, the well has a cylindrical shape. In yet other embodiments, the well has a diameter of about 60 cm and a depth of about 183 cm. The pumping station 130 may further comprise a submersible pump. The submersible pump may be a Little Giant® ½ hp, 115 volts with an hourly cycle.

### Example 9: Pumping Station from Polishing Field to Dephosphatation System

The polishing field 180 may further comprise an outlet connected to or a fluid connection to a pumping station 184 (shown in FIG. 3). The pumping station 130 may further comprise a well. In some embodiments, the well has a cylindrical shape. In yet other embodiments, the well has a diameter of about 38 cm and a depth of about 183 cm. The pumping station 130 may further comprise a submersible pump, such as but not limited to a Little Giant® ½ hp, 115 volts with an hourly cycle.

### Example 10: Pumping Station from Dephosphatation System

The dephosphatation system 160 may further comprise an outlet fluidly connected to a pumping station 170, the outlet may be adapted to direct effluent. The pumping station 170 may further comprise a well. In some embodiments, the well has a cylindrical shape. In yet other embodiments, the well has a diameter of about 38 cm and a depth of about 183 cm. The pumping station 170 may further comprise a submersible pump, such as but not limited to a Little Giant® ½ hp, 115 volts operating on demand following a high-water level float. The pumping system 170 may further comprise an outlet adapted to direct the resulting effluent from the dephosphatation system 160 to the next treatment step, which may be denitrification 140, the polishing step 180 and/or the exit 199.

### Example 11: Low Pressure Partition and Distribution Systems

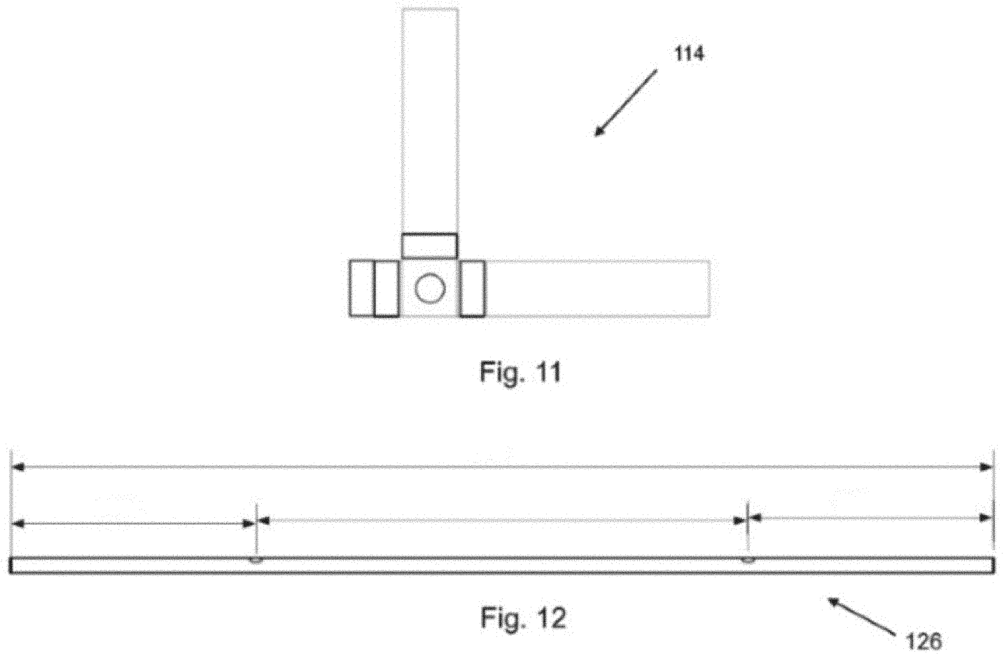

Referring to FIGS. 11 and 12, features of the low-pressure partition system (LPPS) 114 and of the low-pressure distribution system (LPDS) 123 of FIGS. 3 and 4 are shown, respectively. The low-pressure partition system LPPS 114 may partition the feed flow in two separate directions at an angle to feed two treatment lines. In some embodiments, the angle is about 90°. The low-pressure distribution system LPDS 123, which is located within the enviro-septic pipe 122 may, for example, have a length of 10 ft and may further comprise, for example, two distribution holes at 2.5 ft from the ends of the tube and 5 ft apart.

The methods apparatus and systems of the present invention may be used to treat wastewater streams as well as sewage wastewater streams originating from septic tanks.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. A wastewater treatment method for the removal of phosphorus and coliforms comprising the steps of:
settling a wastewater stream in a septic tank;
filtering the wastewater stream through a septic system;
removing phosphorus from the filtered wastewater stream outputted by the septic system through a dephosphatation system; and
filtering the wastewater stream from the dephosphatation system using a polishing field.

2. The wastewater treatment method as defined in claim 28, the method further comprising removing nitrogen from the wastewater stream using a denitrification medium of the denitrification system.

3. (canceled)

4. (canceled)

5. (canceled)

6. A system for the removal of phosphorus and coliforms comprising:
a septic system;
a dephosphatation system fluidly connected to an output of the septic system; and
a polishing field fluidly connected to an output of the dephosphatation system.

7. The system for the removal of phosphorus and coliforms as defined in claim 6, the system further comprising one or more pumping stations.

8. The system for the removal of phosphorus and coliforms as defined in claim 7 further comprising a low-pressure partition system (LPPS) and/or a low-pressure distribution system (LPDS).

9. The system for the removal of phosphorus and coliforms as defined in claim 6, wherein the septic system comprises perforated pipes covered by a geotextile.

10. The system for the removal of phosphorus and coliforms of claim 6, the system being adapted to further remove nitrogen comprising
a denitrification system fluidly connected to the output of septic system,
the polishing field being fluidly connected to an output of the denitrification system.

11. (canceled)

12. (canceled)

13. (canceled)

14. (canceled)

15. (canceled)

16. The system as defined in claim 21, one of the layers of sand filtration medium comprising a septic (AES) pipe in the center and a low-pressure pipe in the AES pipe.

17. The system as defined in claim 6, the dephosphatation system further comprising:
a sealed container; and
a dephosphatation medium installed in the sealed container.

18. The system as defined in claim 17, the dephosphatation system further comprising a dry membrane.

19. The system of claim 10, wherein the denitrification system further comprising:
a compartment; and
a denitrification filtration medium within the compartment.

20. The system as defined in claim 19, the denitrification system further comprising bags of white birch.

21. The system as defined in claim 6, wherein the polishing field further comprises:
a chamber;
one or more layers of materials to be placed in the bottom of said chamber, wherein said layers of materials are selected from the group consisting of crushed stone, geogrid, sand filtration media and fill soil; and
one or more openings adapted to receive a ventilation pipe, a piezometer, one or more pipes from a low-pressure partition system (LPPS), one or more pipes from a low-pressure distribution system (LPDS), one or more pipes from a dephosphatation system and/or one or more pipes from a denitrification system.

22. The system as defined in claim 21, wherein the polishing field comprises the following layers to be placed at the bottom of the chamber:
a first layer having a rough filtration medium;
a second layer of geogrid;
a third layer of fine filtration medium;
a fourth layer of fine filtration medium;
a fifth layer of fine filtration medium; and
a sixth layer of sand or backfill soil taken on site.

23. The system as defined in claim 22, the fine filtration medium being sand.

24. The system as defined in claim 22, the rough filtration medium being crushed stones.

25. The system as defined in claim 21, further comprising a collection drain at the base of the chamber.

26. The wastewater treatment method of claim 1 further comprising passing the wastewater through a sealed container of the dephosphatation system.

27. The wastewater treatment method of claim 26 further comprising passing the wastewater through a dry membrane of the dephosphatation system.

28. The wastewater treatment method of claim 1 further comprising removing nitrogen from the wastewater stream with a denitrification system fluidly connected to the septic system.
